(19) United States
(12) Patent Application Publication
(10) Pub. No.: US 2025/0322818 A1
(43) Pub. Date: Oct. 16, 2025

(54) SOUND SIGNAL PROCESSING DEVICE, MUSICAL INSTRUMENT, SOUND SIGNAL PROCESSING METHOD, AND NON-TRANSITORY COMPUTER-READABLE STORAGE MEDIUM

(71) Applicant: Yamaha Corporation, Hamamatsu-shi (JP)

(72) Inventor: Yasuhito ISHIHARA, Hamamatsu-shi (JP)

(21) Appl. No.: 19/065,162

(22) Filed: Feb. 27, 2025

(30) Foreign Application Priority Data
Apr. 15, 2024 (JP) 2024-065683

(51) Int. Cl. G10H 1/36; G10H 1/00

(52) U.S. Cl. CPC G10H 1/366; G10H 1/0008; G10H 2210/281; G10H 2210/331

(57) ABSTRACT

A sound signal processing device includes a memory and a processor. The memory stores instructions. The processor implements the instructions to input a first sound signal, perform a first signal processing that includes at least first pitch shifting on the first sound signal, and output a first effect processing signal. The processor also implements the instructions to input a second sound signal, perform a second signal processing that includes at least second pitch shifting on the second sound signal, and output a second effect processing signal. The processor also implements the instructions to perform a cross-couple processing of the first effect processing signal and the second effect processing signal. The processor also implements the instructions to set a parameter that imparts continuous variation to a degree of coupling of the first effect processing signal and the second effect processing signal in the cross-couple processing.

### CROSS-REFERENCE TO RELATED APPLICATIONS

The present application claims priority under 35 U.S.C. § 119 to Japanese Patent Application No. 2024-065683, filed Apr. 15, 2024. The contents of this application are incorporated herein by reference in their entirety.

### BACKGROUND

The present disclosure relates to a sound signal processing device, a musical instrument including the sound signal processing device, a sound signal processing method, and a sound signal processing program.

There is a sound signal processing device that performs various sound processing on an input sound signal. The December 1971 issue of “studio sound” magazine discloses at page 634 a sound signal processing device with signal processing sections of two systems including delay processing and loop processing. Cross-coupling is performed between signal processing of the two systems in this device.

Signals of the two systems can be cross-coupled in the device disclosed in the “studio sound” magazine. If a mechanism enabling more flexible processing in cross-coupling is provided, the mechanism is highly convenient for a user.

It is an object of the present disclosure to provide a sound signal processing technology that enables various expressions by an intuitive and flexible operation of the user.

### SUMMARY

One aspect is a sound signal processing section that includes a memory and a processor. The memory stores instructions. The processor implements the instructions to input a first sound signal, perform a first signal processing that includes at least first pitch shifting on the first sound signal, and output a first effect processing signal. The processor also implements the instructions to input a second sound signal, perform a second signal processing that includes at least second pitch shifting on the second sound signal, and output a second effect processing signal. The processor also implements the instructions to perform a cross-couple processing of the first effect processing signal and the second effect processing signal. The processor also implements the instructions to set a parameter that imparts continuous variation to a degree of coupling of the first effect processing signal and the second effect processing signal in the cross-couple processing.

Another aspect is a musical instrument that includes the above-described sound signal processing device and a performance operator including a keyboard.

Another aspect is a sound signal processing method that includes inputting a first sound signal, performing first pitch shifting on the first sound signal, and outputting a first effect processing signal. The sound signal processing method also includes inputting a second sound signal, performing second pitch shifting on the second sound signal, and outputting a second effect processing signal. The sound signal processing method also includes cross-coupling the first effect processing signal and the second effect processing signal. The sound signal processing method also includes setting a parameter that imparts continuous variation to a degree of coupling in the cross-coupling of the first effect processing signal and the second effect processing signal in the cross-coupling.

Another aspect is a non-transitory computer-readable storage medium storing a sound signal processing program. The sound signal processing program is executable by at least one processor to execute a method that includes inputting a first sound signal, performing first pitch shifting on the first sound signal, and outputting a first effect processing signal. The method also includes inputting a second sound signal, performing second pitch shifting on the second sound signal, and outputting a second effect processing signal. The method also includes cross-coupling the first effect processing signal and the second effect processing signal. The method also includes cross-coupling the first effect processing signal and the second effect processing signal. The method also includes setting a parameter that imparts continuous variation to a degree of coupling in the cross-coupling of the first effect processing signal and the second effect processing signal in the cross-coupling.

A more complete appreciation of the present disclosure and many of the attendant advantages thereof will be readily obtained as the same becomes better understood by reference to the following detailed description when considered in connection with the following figures, in which:

### BRIEF DESCRIPTION OF THE DRAWINGS

FIG. 1 is a configuration diagram of a musical instrument according to one embodiment;

FIG. 2 is a block diagram illustrating a functional configuration of a musical instrument according to one embodiment;

FIG. 3 is a functional block diagram illustrating a sound signal processing section according to one embodiment;

FIG. 4 is a functional block diagram illustrating details of a sound signal processing section according to one embodiment;

FIG. 5 is a diagram illustrating an interface for adjusting a gain of an amplification processing section of a cross-coupling section;

FIG. 6 is a diagram illustrating a relationship of the gain of the amplification processing section of the cross-coupling section; and

FIG. 7 is a diagram illustrating another embodiment for adjusting the gain of the amplification processing section of the cross-coupling section.

### DETAILED DESCRIPTION

The present specification is applicable to a sound signal processing device, a musical instrument, a sound signal processing method, and a sound signal processing program.

A sound signal processing device, a musical instrument, a sound signal processing method, and a non-transitory computer-readable storage medium according to one embodiment will be described below with reference to the accompanying drawings.

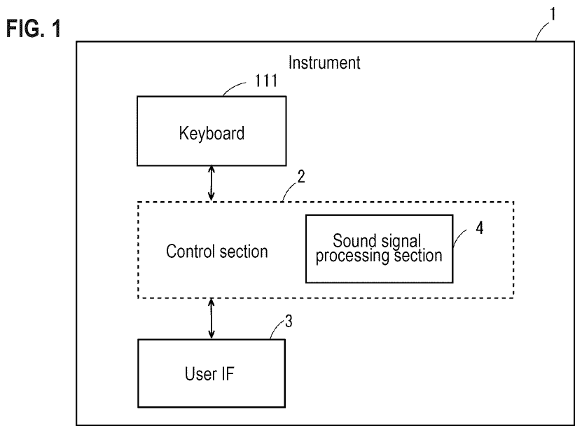

FIG. 1 is a schematic configuration diagram of the musical instrument 1 including the sound signal processing section 4 according to the present embodiment. The musical instrument 1 includes a keyboard 111, a controller 2, and a user interface (user IF) 3. The controller 2 includes the sound signal processing section 4. The present embodiment is described by exemplifying a case where the musical instrument 1 is an electronic keyboard including the keyboard 111.

The controller 2 performs overall control of the musical instrument 1. If a user performs an operation on the user IF 3, various instructions are given to the controller 2 by the operation input by the user IF 3. The sound signal processing section 4 adds various effects to a sound signal output by the musical instrument 1.

In the present embodiment, the sound signal processing section 4 performs processing of pitch shifting of the sound signal and processing of adding reverb effect to the sound signal. For example, the sound signal processing section 4 can produce a fantastic deep sound, such as a so-called shimmer reverb, by adding the reverb effect to the sound signal after subjected to the pitch shifting. Shimmer reverb contributes to obtaining, for example, an effect such that reverberant sound gradually changes to a high tone, an effect such that reverberant sound gradually changes to a low tone, and an effect such that reverberant sound repeats a high tone and a low tone.

In the present embodiment, the sound signal processing section 4 performs cross-coupling of coupling signals of two systems in order to further add an effect to the sound signal after addition of the pitch shifting and the reverb effect. The terms “cross-coupling” and “cross-couple processing” as used in the present specification each indicate processing in which the signals of the two systems are input and the signals of the two systems are coupled (mixed) together to output a coupling signal of new two systems. A parameter that is continuous numbers is used for adjusting a degree of coupling of the signals of the two systems in the present disclosure. Specifically, a first coupling signal is generated by respectively multiplying the input signals of the two systems by two kinds of gains according to the parameter, and then adding their respective results together. It is also configured to output a second coupling signal by multiplying the input signals of the two systems by two kinds of gains, which are different from (or the same as) those used when generating the first coupling signal, according to the parameter, and then adding their respective results together.

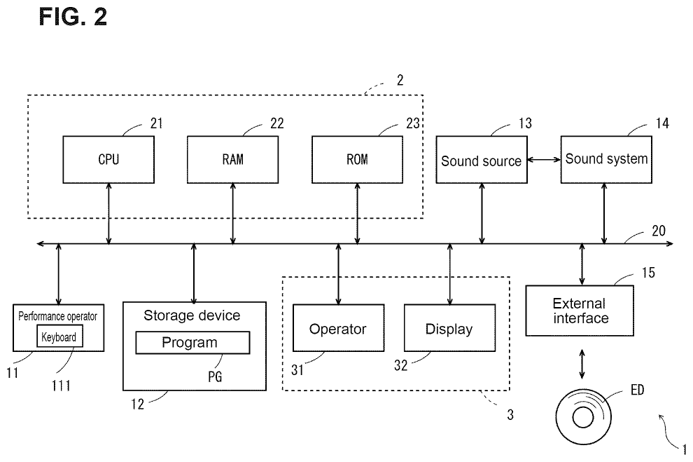

FIG. 2 is a block diagram illustrating a functional configuration of the musical instrument 1. As illustrated in FIG. 2, the musical instrument 1 includes a performance operator 11, a storage device 12, a sound source 13, a sound system 14, a controller 2, a user IF 3, and an external interface 15. The controller 2 includes a CPU (Central Processing Unit) 21, a RAM (Random Access Memory) 22, and a ROM (Read Only Memory) 23. The user IF 3 includes an operator 31 and a display 32. The CPU 21 corresponds to a processor.

The performance operator 11 includes a keyboard 111, and is connected to a bus 20. The keyboard 111 has an arrangement of a plurality of keys. The keyboard 111 includes 88 keys in the present embodiment. However, the number of keys included in the keyboard 111 need not be the number described above. For example, the keyboard 111 may be configured to include 61 keys. The keyboard 111 of the performance operator 11 may be an image of a keyboard displayed on a screen of a touch panel display described later.

The storage device 12 includes a storage medium, such as a hard disk, an optical disk, or a memory card. Computer programs, such as a program PG and a control program, are stored in the storage device 12. The program PG is a program for executing sound signal processing.

The CPU 21, the RAM 22, and the ROM 23 are connected to each other through the bus 20. The RAM 22 includes, for example, a volatile memory, and is used as an operation region of the CPU 21 and temporarily stores various data. The ROM 23 includes, for example, a non-volatile memory, and stores various programs, setting data, etc. The CPU 21 executes the programs stored in the storage device 12 or the ROM 23, while using the RAM 22 as a work area.

The sound source 13 is connected to the bus 20, and outputs an audio data (sound signal) based on a pitch designated by an operation of the keyboard 111. The audio data are sampling data indicating a sound waveform (for example, PCM (pulse code modulation) data). Hereinafter, the audio data output from the sound source 13 are called a sound signal. The sound source 13 previously stores sound signals of all pitches. The sound system 14 includes a digital-to-analog (D/A) conversion circuit, an amplifier, and a speaker. The sound system 14 converts the sound signal given from the sound source 13 to an analog sound signal, and generates sound based on the analog sound signal.

An operator 31 includes, for example, an operating switch for on/off operation, an operating switch for rotation operation, or an operating switch for slide operation, and is connected to the bus 20. The operator 31 is used for making various settings including power on/off, volume adjustment, and setting for adding various effects to a sound signal output from the musical instrument 1. The operator 31 may be used for a playing operation. The display 32 includes, for example, a liquid crystal display, and is connected to the bus 20. A title of a musical composition, a sheet music, or other various information are displayed on the display 32. The display 32 may be a touch panel display. In this case, part or all of the keyboard 111 or the operator 31 may be displayed on the display 32. A player is capable of instructing various operations by operating the display 32.

The external interface 15 is an interface for connecting to an external storage medium ED and a network. The CPU 21 is accessible through the external interface 15 to the storage medium ED, such as CD-ROM, DVD, MD, and USB storage memory.

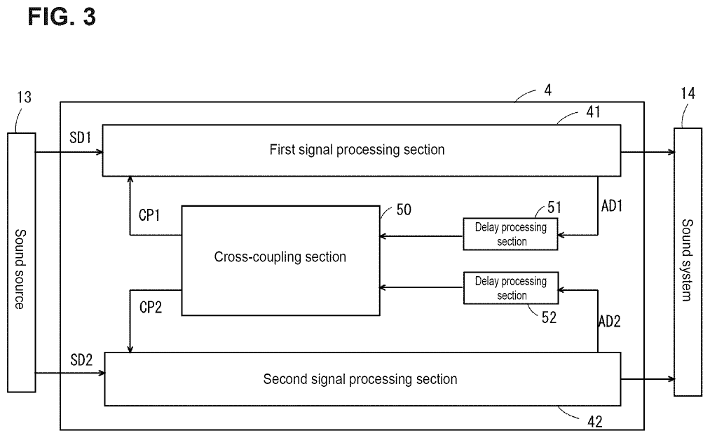

A configuration of the sound signal processing section 4 according to the present embodiment is described below. FIG. 3 is a block diagram illustrating the sound signal processing section 4 according to one embodiment of the present disclosure.

The sound signal processing section 4 includes a first signal processing section 41, a second signal processing section 42, a cross-coupling section 50, and delay processing sections 51 and 52. The sound signal processing section 4 is a functional unit implemented in a situation where the CPU 21 executes the program PG stored in the storage device 12 while using hardware resources, such as the RAM 22. That is, the first signal processing section 41, the second signal processing section 42, the cross-coupling section 50, and the delay processing sections 51 and 52 are functional units implemented by execution of the program PG. The sound signal processing section 4 is one embodiment of the sound signal processing device according to the embodiment of the present disclosure.

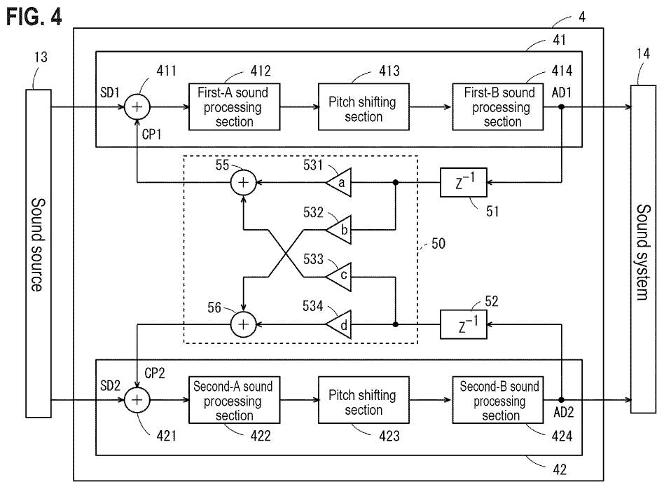

FIG. 4 is a block diagram illustrating in more detail the sound signal processing section 4 according to the embodiment. FIG. 4 illustrates a functional block for describing a processing flow of the first signal processing section 41, the second signal processing section 42, and the cross-coupling section 50.

The sound signal processing section 4 includes the first signal processing section 41, the second signal processing section 42, the delay processing sections 51 and 52, and the cross-coupling section 50. The first signal processing section 41 includes an addition processing section 411, a first-A sound processing section 412, a pitch shifting section 413, and a first-B sound processing section 414. The second signal processing section 42 includes an addition processing section 421, a second-A sound processing section 422, a pitch shifting section 423, and a second-B sound processing section 424. The cross-coupling section 50 includes amplification processing sections 531, 532, 533, and 534, and addition processing sections 55 and 56.

The addition processing section 411 of the first signal processing section 41 adds a first sound signal SD1 output from the sound source 13, and a first coupling signal CP1 output from the cross-coupling section 50. The first-A sound processing section 412 of the first signal processing section 41 subjects a sound signal output from the addition processing section 411 to first-A sound processing. The first-A sound processing includes, for example, reverb processing, high pass filtering, low pass filtering, equalizer processing, and delay processing. The pitch shifting section 413 of the first signal processing section 41 subjects a sound signal output from the first-A sound processing section 412 to pitch shifting. The first-B sound processing section 414 of the first signal processing section 41 subjects a sound signal output from the pitch shifting section 413 to first-B sound processing. The first-B sound processing includes, for example, reverb processing, high pass filtering, low pass filtering, equalizer processing, and delay processing. Thus, the first signal processing section 41 executes effect processing including pitch shifting on the first sound signal SD1.

The addition processing section 421 of the second signal processing section 42 adds a second sound signal SD2 output from the sound source 13, and a second coupling signal CP2 output from the cross-coupling section 50. The second-A sound processing section 422 of the second signal processing section 42 subjects a sound signal output from the addition processing section 421 to second-A sound processing. The second-A sound processing includes, for example, reverb processing, high pass filtering, low pass filtering, and equalizer processing. The pitch shifting section 423 of the second signal processing section 42 subjects a sound signal output from the second-A sound processing section 422 to pitch shifting. The second-B sound processing section 424 of the second signal processing section 42 subjects a sound signal output from the pitch shifting section 423 to first-B sound processing. The second-B sound processing includes, for example, reverb processing, high pass filtering, low pass filtering, and equalizer processing. Thus, the second signal processing section 42 executes effect processing including pitch shifting on the second sound signal SD2.

The first-A sound processing section 412 and the second-A sound processing section 422 perform identical processing on an input sound signal in the present embodiment. The first-B sound processing section 414 and the second-B sound processing section 424 also perform identical processing on an input sound signal in the present embodiment. However, the first-A sound processing section 412 and the second-A sound processing section 422 may execute different processing on the input sound signal. The first-B sound processing section 414 and the second-B sound processing section 424 may execute different processing on the input sound signal. The pitch shifting section 413 and the pitch shifting section 423 may execute different pitch shifting.

The present embodiment is described by exemplifying a case where the first sound signal SD1 and the second sound signal SD2 are identical to each other. However, the first sound signal SD1 and the second sound signal SD2 may be different from each other.

The first signal processing section 41 outputs a first effect processing signal AD1 after subjected to effect processing to the sound system 14 and the cross-coupling section 50. The second signal processing section 42 outputs a second effect processing signal AD2 after subjected to effect processing to the sound system 14 and the cross-coupling section 50.

The delay processing section 51 inputs the first effect processing signal AD1 and holds the input first effect processing signal AD1 for one sampling period. The delay processing section 51 outputs the held first effect processing signal AD1 to the amplification processing section 531 and the amplification processing section 532 at a subsequent sampling timing. The delay processing section 52 inputs a second effect processing signal AD2 and holds the input second effect processing signal AD2 for one sampling period. The delay processing section 52 outputs the held second effect processing signal AD2 to the amplification processing section 533 and the amplification processing section 534 at a subsequent sampling timing.

The amplification processing section 531 and the amplification processing section 532 respectively multiply a sound signal output from the delay processing section 51 by gains a and b, and respectively output sound signals after multiplication of the gain. The amplification processing section 533 and the amplification processing section 534 respectively multiply a sound signal output from the delay processing section 52 by gains c and d, and respectively output sound signals after multiplication of the gain.

The addition processing section 55 adds the sound signal output from the amplification processing section 531, and the sound signal output from the amplification processing section 533, and then outputs an additional signal as a first coupling signal CP1. The addition processing section 56 adds the sound signal output from the amplification processing section 532, and the sound signal output from the amplification processing section 534, and then outputs an additional signal as a second coupling signal CP2.

In the sound signal processing section 4 configured as described above, the first signal processing section 41 executes effect processing including the first-A sound processing, the pitch shifting, and the first-B sound processing on the first sound signal SD1. Concurrently, the second signal processing section 42 executes the effect processing including the second-A sound processing, the pitch shifting, and the second-B sound processing on the second sound signal SD2. A first effect processing signal AD1 after subjected to the effect processing which is output from the first signal processing section 41, and a second effect processing signal AD2 after subjected to the effect processing which is output from the second signal processing section 42 are adjusted in terms of degree of coupling by gains a, b, c, and d, and thereafter cross-coupled in the cross-coupling section 50. Then, the first coupling signal CP1 is fed back to the first signal processing section 41, and is added to the first sound signal SD1 output from the sound source 13. The second coupling signal CP2 is fed back to the second signal processing section 42, and is added to the second sound signal SD2 output from the sound source 13. Thus, the cross-coupling and the feedback processing are repeated on the signals after subjected to the effect processing in the first signal processing section 41 and the second signal processing section 42.

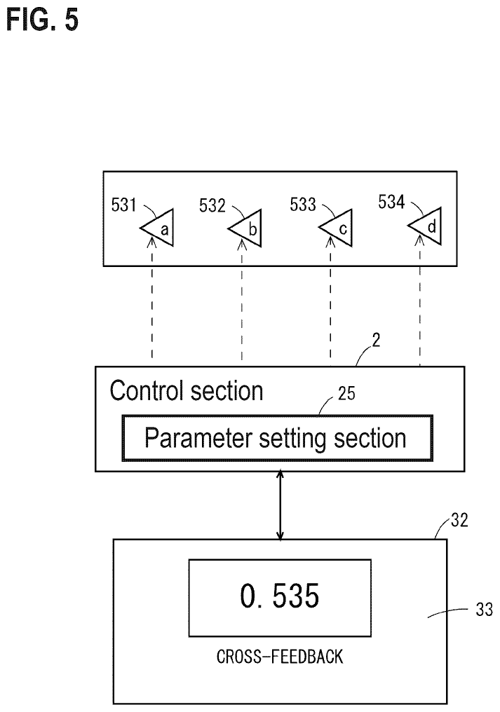

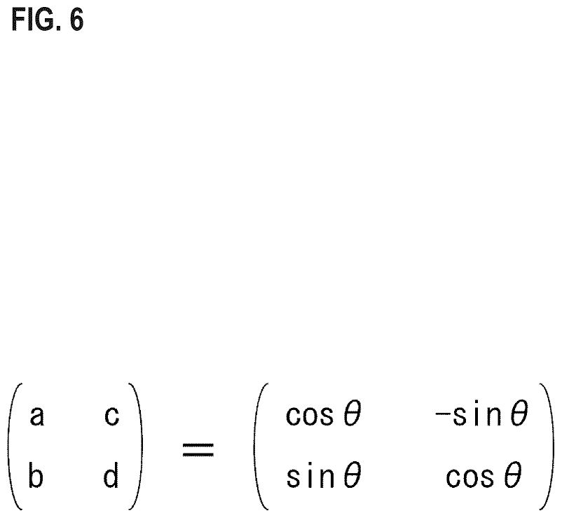

A method for adjusting a degree of coupling in the cross-coupling section 50 is described below with reference to FIGS. 5 and 6. FIG. 5 is a diagram illustrating a user interface for adjusting gains of the amplification processing sections 531 to 534 in the cross-coupling section 50. FIG. 6 is a diagram illustrating a relationship of the gains of the amplification processing sections 531 to 534 in the cross-coupling section 50.

A setting screen 33 for cross-coupling is displayed on the display 32 as illustrated in FIG. 5. An operation interface including the setting screen 33 is created by execution of a program stored in the storage device 12 or the ROM 23. The program may be included in the program PG. A user inputs a parameter indicating a degree of coupling in cross-coupling by operating the operator 31 on the setting screen 33 displayed on the display 32. The user can set the parameter indicating the degree of coupling by consecutive numbers as illustrated in FIG. 5. In an illustrative example, the user can set numbers up to three decimal places in a range of 0.000 to 1.000.

Upon input of the parameter to the setting screen 33 by the operation through the operator 31, the parameter setting section 25 of the controller 2 receives an input parameter. The parameter setting section 25 is created by the execution of the program stored in the storage device 12 or the ROM 23. The program may be included in the program PG. The parameter setting section 25 sets gains a, b, c, and d of the amplification processing sections 531 to 534 in the sound signal processing section 4 according to the input parameter. The amplification processing sections 531 to 534 are configured so that their respective gains are changeable by an instruction of the parameter setting section 25.

The parameter setting section 25 sets so that gains a, b, c, and d of the amplification processing sections 531 to 534 become matrix elements of a rotation matrix of a rotation angle θ as illustrated in FIG. 6. Thereby, the cross-coupling section 50 outputs CP1=a·AD1+c·AD2=cos θ·AD1−sin θ·AD2 as a first coupling signal CP1, and outputs CP2=b·AD1+d·AD2=sin θ·AD1+cos θ·AD2 as a second coupling signal CP2.

In the case of the configuration of FIGS. 4, AD1 and AD2 are respectively signals of the preceding sample with respect to CP1 and CP2 in the above equation.

If the user sets a parameter 0.000 on the setting screen 33, a rotation angle θ=0° is set. Thereby, the cross-coupling section 50 outputs AD1 one sample later as the first coupling signal CP1, and outputs AD2 one sample later as the second coupling signal CP2. That is, the signals respectively output from the first signal processing section 41 and the second signal processing section 42 are fed back without being coupled together (without being distributed).

If the user sets a parameter 1.000 on the setting screen 33, a rotation angle θ=90° is set. Thereby, the cross-coupling section 50 outputs—AD2 one sample later as the first coupling signal CP1, and outputs AD1 one sample later as the second coupling signal CP2. That is, the signals respectively output from the first signal processing section 41 and the second signal processing section 42 are completely cross fed back.

If the user set any value from 0.000 to 1.000 as a parameter on the setting screen 33, a rotation angle of 0°<θ<90° is set, and a degree of coupling (degree of distribution) of the signals respectively output from the first signal processing section 41 and the second signal processing section 42 is adjusted accordingly.

Thus, the sound signal processing section 4 of the present embodiment is configured so that the gains of the amplification processing sections 531 to 534 are freely settable by the user, and therefore, the degree of coupling in the cross-coupling section 50 is freely adjustable by the user. Thereby, it is possible to output a sound signal after addition of the effect according to a preference of the user by freely mixing, according to the preference of the user, feedback signals of the first effect processing signal AD1 after subjected to the pitch shifting in the first signal processing section 41, and the second effect processing signal AD2 after subjected the pitch shifting in the second signal processing section 42. Because the user can set the degree of coupling in cross-coupling by the consecutive numbers as described above, the cross-coupling is settable in detail and intuitively according to the preference of the user. Unlike discrete settings, such as ON/OFF of effects and mode change, continuous variation can be imparted to the effects by setting numbers. Thus, it is possible to impart variation to the effect in real time, for example, during real-time performance.

It is also possible to cause the first-A sound processing section 412 or the first-B sound processing section 414 to execute reverb processing, and cause the second-A sound processing section 422 or the second-B sound processing section 424 to execute reverb processing. In this case, feedback signals of a first effect processing signal AD1 after subjected to the reverb processing and the pitch shifting in the first signal processing section 41, and a second effect processing signal AD2 after subjected to the reverb processing and the pitch shifting in the second signal processing section 42 can be freely mixed together according to the preference of the user. Thereby, it is possible to output a sound signal after addition of shimmer reverb effect according to the preference of the user. Because the user can set the degree of coupling in cross-coupling by the consecutive numbers as described above, the shimmer reverb effect according to the preference of the user is settable in detail and intuitively.

In the embodiment illustrated in FIG. 5, the user adjusts the degree of coupling in cross-coupling by operating the operator 31 so as to freely input the parameter of the cross-coupling to the setting screen 33. Alternatively, if the display 32 is the touch panel display as described above, the player is capable of inputting the parameter of the cross-coupling by operating a GUI displayed on the display 32. As another embodiment, the parameter setting section 25 may be configured to set the gains a, b, c, and d using a previously prepared parameter dataset PD.

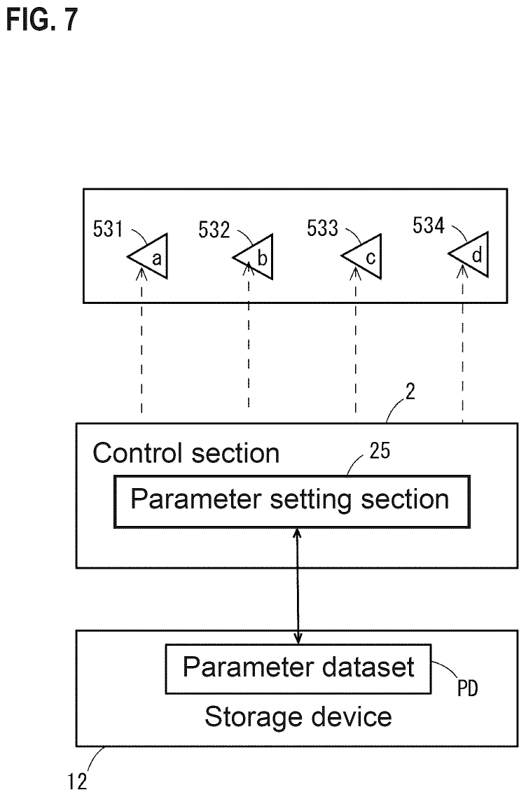

FIG. 7 is a diagram illustrating a parameter setting method according to another embodiment. A parameter setting dataset PD is stored in the storage device 12. The parameter dataset PD is data in which a parameter indicating a degree of coupling in cross-coupling is set. The parameter setting section 25 reads out the parameter dataset PD from the storage device 12, and sets the gains a, b, c, and d of the amplification processing sections 531 to 534 according to the parameter set in the parameter dataset PD.

In the above embodiment, the pitch shifting is placed in a forward section within feedback loop processing. As another embodiment, the pitch shifting may be placed in a feedback section within the feedback loop processing. That is, either one or both of the pitch shifting section 413 and the pitch shifting section 423 may be placed in the feedback section within the feedback loop processing.

In the above embodiment, the cross-coupling is placed in the feedback section within the feedback loop processing. As another embodiment, the cross-coupling may be placed in the forward section within the feedback loop processing. If both of the pitch shifting and the cross-coupling are placed in the forward section, it is possible to obtain a characteristic where signals of two systems after subjected to pitch shifting are alternately exchanged.

In the above embodiment, for example, shimmer reverb effect is settable in detail according to the preference of the user by adjusting the degree of coupling in cross-coupling. As an application example of the embodiment of the present disclosure, the cross-coupling section 50 according to the embodiment of the present disclosure may be applied to a voice changer. For example, a voice conversion having high privacy protection performance can be performed by inputting a voice signal of a user as a first sound signal SD1 and a second sound signal SD2, followed by processing in the sound signal processing section 4 including the cross-coupling section 50 according to the embodiment of the present disclosure. Here, the privacy protection performance can be further improved by changing the gains of the amplification processing sections 531 to 534 at random as time advances. If the gains a, b, c, and d of the amplification processing sections 531 to 534 are directly changed at random, signals to be fed back can diverge. However, the gains a, b, c, and d can be changed indirectly at random in a range of numbers smaller than 1 by changing the rotation angle θ at random. Because the degree of coupling of the cross-coupling is settable by consecutive numbers, it is possible to change the degree of coupling in cross-coupling as time advances during reproduction of an input voice signal. For example, parameters changed at random as time advances may be set in the above parameter dataset PD. The input voice signal may be given to the parameter setting section 25 as a parameter. For example, a determination as to whether the voice signal is a vowel or consonant may be made, and an appropriate parameter may be set. It is also possible to configure so that a parameter according to a determination result can be selected by preparing a dataset of parameters according to determination results of vowels/consonants in the parameter dataset PD. Alternatively, a feature value may be extracted from the input voice signal, and a parameter may be set by a randomization method according to the feature value.

In the above embodiment, the relationship using the rotation matrix as illustrated in FIG. 6 is established as the gains a, b, c, and d. A transposed matrix of the rotation matrix may be used as another embodiment. Alternatively, a method including simply adding the first coupling signal CP1 and the second coupling signal CP2, and decreasing a gain in a portion whose norm exceeds 1 may be used without using the rotation matrix.

Although the sound signal processing section 4 includes the first-A sound processing section 412, the first-B sound processing section 414, the second-A sound processing section 422, and the second-B sound processing section 424 in the above embodiment, part or all of these sections may be bypass processing sections (through processing sections) that allow a signal to pass through as it is.

Although the delay processing sections 51 and 52 are placed right before the cross-coupling section 50 in the above embodiment, they need not be placed in this way. The delay processing sections 51 and 52 may be placed in other positions. Alternatively, the delay processing section 51 may be included in either one of the first-A sound processing section 412, the pitch shifting section 413, and the first-B sound processing section 414. The delay processing section 52 may be included in either one of the second-A sound processing section 422, the pitch shifting section 423, and the second-B sound processing section 424.

In the above embodiment, the first coupling signal CP1 is fed back to the first signal processing section 41 in the addition processing section 411, and the second coupling signal CP2 is fed back to the second signal processing section 42 in the addition processing section 421. The position to which the first coupling signal CP1 and the second coupling signal CP2 are fed back need not be the position described above. The first coupling signal CP1 and the second coupling signal CP2 may be fed back to the position of either one of the first signal processing section 41 and the second signal processing section 42.

The above embodiment has been described by exemplifying the case where the program PG is stored in the storage device 12. As another embodiment, the program PG may be stored in and provided by the storage medium ED. The CPU 21 may access to the storage medium ED through the external interface 15, and may store the program PG stored in the storage medium ED in the storage device 12 or the ROM 23. Alternatively, the CPU 21 may access to the storage medium ED through the externa interface 15, and may execute the program stored in the storage medium ED. Alternatively, the CPU 21 may download a program PG from a server on a network through a communication interface, and may store the downloaded program PG in the storage device 12 or the ROM 23. Alternatively, the CPU 21 may directly execute the program PG stored in the server on the network through the communication interface.

(1) A sound signal processing device includes a first signal processing section 41, a second signal processing section 42, a cross-coupling section 50, and a parameter setting section 25. The first signal processing section 41 is configured to input a first sound signal SD1 and perform first pitch shifting on the first sound signal SD1. The second signal processing section 42 is configured to input a second sound signal SD2 and perform second pitch shifting on the second sound signal SD2. The cross-coupling section 50 is configured to perform cross-coupling of a first effect processing signal AD1 output from the first signal processing section, and a second effect processing signal AD2 output from the second signal processing section 42. The parameter setting section 25 is configured to set to the cross-coupling section 50 a parameter that imparts continuous variation to a degree of coupling of the first effect processing signal AD1 and the second effect processing signal AD2.

It is possible to flexibly change the degree of coupling of the first effect processing signal AD1 and the second effect processing signal AD2.

(2) The sound signal processing device described in the above (1) may further include a user interface configured to input a user instruction to the parameter setting section 25.

It is possible to flexibly change the degree of coupling of the first effect processing signal AD1 and the second effect processing signal AD2 by a user operation. The user is capable of controlling the degree of coupling of outputs of two systems by an intuitive operation.

(3) In the sound signal processing device described in the above (1), the parameter setting section 25 may set the parameter to the cross-coupling section 50 based on a parameter dataset in which the parameter is set.

It is possible to flexibly change the degree of coupling of the first effect processing signal AD1 and the second effect processing signal AD2 based on the set parameter dataset.

(4) In the sound signal processing device described in the above (1), each of the first signal processing section 41 and the second signal processing section 42 may include a reverb processing section.

It is possible to flexibly change the degree of coupling of the first effect processing signal AD1 and the second effect processing signal AD2 in the sound signal processing device using a combination of pitch shifting and reverb.

(5) In the sound signal processing device described in the above (1), each of the first signal processing section 41 and the second signal processing section 42 may include a feedback processing section.

It is possible to flexibly change the degree of coupling of the first effect processing signal AD1 and the second effect processing signal AD2 in the sound signal processing device using the combination of pitch shifting and reverb.

(6) In the sound signal processing device described in the above (1), the cross-coupling section 50 may include rotation matrix processing, and the parameter setting section 25 may set a matrix element of a rotation matrix by the parameter.

It is possible to flexibly change the degree of coupling of the first effect processing signal AD1 and the second effect processing signal AD2 by setting the matrix element of the rotation matrix.

(7) In the sound signal processing device described in the above (1), the first signal processing section 41 and the second signal processing section 42 may execute identical signal processing on an input sound signal.

It is possible to flexibly change the degree of coupling of the first effect processing signal AD1 and the second effect processing signal AD2 respectively output from signal processing sections of identical two systems.

In the sound signal processing device described in the above (5), a processing section that performs pitch shifting may be placed in a forward section within feedback loop processing.

In the sound signal processing device described in the above (5), a processing section that performs pitch shifting may be placed in a feedback section within the feedback loop processing.

In the sound signal processing device described in the above (5), the cross-coupling section 50 may be placed in a forward section within the feedback loop processing.

In the sound signal processing device described in the above (5), the cross-coupling section 50 may be placed in the feedback section within the feedback loop processing.

(8) A musical instrument includes the sound signal processing device described in any one of the above (1) to (7).

(9) A sound signal processing method includes inputting a first sound signal SD1 and performing first pitch shifting on the first sound signal SD1 in a first signal processing section 41. A second sound signal SD2 is input, and second pitch shifting on the second sound signal SD2 is performed in a second signal processing section 42. A first effect processing signal AD1 output from the first signal processing section 41, and a second effect processing signal AD2 output from the second signal processing section 42 are cross-coupled. A parameter that imparts continuous variation to a degree of coupling in cross-coupling of the first effect processing signal AD1 and the second effect processing signal AD2 is set.

It is possible to flexibly change the degree of coupling of the first effect processing signal AD1 and the second effect processing signal AD2.

(10) A non-transitory computer-readable storage medium stores a program that causes a computer to execute a sound signal processing method. The program causes the computer to perform first signal processing of inputting a first sound signal SD1 and performing first pitch shifting on the first sound signal SD1. Second signal processing of inputting a second sound signal SD2 and performing second pitch shifting on the second sound signal SD2 is executed. Cross-coupling of a first effect processing signal AD1 output from the first signal processing and a second effect processing signal AD2 output from the second signal processing is executed. Processing of setting a parameter that imparts continuous variation to a degree of coupling in the cross-coupling of the first effect processing signal AD1 and the second effect processing signal AD2 is executed.

It is possible to flexibly change the degree of coupling of the first effect processing signal AD1 and the second effect processing signal AD2.

(11) In the above-described configuration, a sound signal processing device includes means for implementing the method described in the above (9).

(12) In the above-described configuration, a computer program includes an instruction that causes the computer to implement the method described in the above (9).

(13) In the above-described configuration, a computer-readable storage medium having a computer program stored therein stores therein the computer program described in the above (12).

It is to be noted that the musical instrument will not be not limited to a keyboard instrument. It is also possible to use any string instrument incorporating an effector (sound signal processing section), such as an electric guitar. In this case, performance is carried out by operating the strings. It is also possible to use any wind instrument incorporating a sound signal processing section, such as a digital saxophone. In this case, performance is executed through a combination of blowing and key operations. It is also possible to use any percussion instrument incorporating a sound signal processing section, such as electronic drums. In this case, performance is executed by striking the drumhead. Performance is executed using performance operation elements such as keyboards, strings, keys, and drumheads.

With the embodiments of the present disclosure, it is possible to provide the sound signal processing device, the musical instrument, the sound signal processing method, and the non-transitory computer-readable storage medium, which are intended to enable the various expressions by the intuitive and flexible operation by the user.

While embodiments of the present disclosure have been described, the embodiments are intended as illustrative only and are not intended to limit the scope of the present disclosure. It will be understood that the present disclosure can be embodied in other forms without departing from the scope of the present disclosure, and that other omissions, substitutions, additions, and/or alterations can be made to the embodiments. Thus, these embodiments and modifications thereof are intended to be encompassed by the scope of the present disclosure. The scope of the present disclosure accordingly is to be defined as set forth in the appended claims.

What is claimed is:

1. A sound signal processing device comprising:
a memory storing instructions; and
a processor that implements the instructions to:
input a first sound signal, perform a first signal processing that includes at least first pitch shifting on the first sound signal, and output a first effect processing signal;
input a second sound signal, perform a second signal processing that includes at least second pitch shifting on the second sound signal, and output a second effect processing signal;
perform a cross-couple processing of the first effect processing signal and the second effect processing signal; and
set a parameter that imparts continuous variation to a degree of coupling of the first effect processing signal and the second effect processing signal in the cross-couple processing.

2. The sound signal processing device according to claim 1, further comprising a user interface configured to input a user instruction for setting the parameter.

3. The sound signal processing device according to claim 1, wherein the processor sets the parameter from a parameter dataset.

4. The sound signal processing device according to claim 1, wherein each of the first and second signal processings includes a reverb processing.

5. The sound signal processing device according to claim 1, wherein each of the first and second signal processings includes a feedback processing.

6. The sound signal processing device according to claim 1, wherein:
the cross-coupling processing includes a rotation matrix processing, and
the parameter sets a matrix element of a rotation matrix.

7. The sound signal processing device according to claim 1, wherein the first signal processing and the second signal processing are identical.

8. A musical instrument comprising:
the sound signal processing device according to claim 1; and
a performance operator.

9. A sound signal processing method comprising:
inputting a first sound signal, performing first pitch shifting on the first sound signal, and outputting a first effect processing signal;
inputting a second sound signal, performing second pitch shifting on the second sound signal, and outputting a second effect processing signal;
cross-coupling the first effect processing signal and the second effect processing signal; and
setting a parameter that imparts continuous variation to a degree of coupling in the cross-coupling of the first effect processing signal and the second effect processing signal in the cross-coupling.

10. A non-transitory computer-readable storage medium storing a sound signal processing program executable by at least one processor to execute a method comprising:
inputting a first sound signal, performing first pitch shifting on the first sound signal, and outputting a first effect processing signal;
inputting a second sound signal, performing second pitch shifting on the second sound signal, and outputting a second effect processing signal;
cross-coupling the first effect processing signal and the second effect processing signal; and
setting a parameter that imparts continuous variation to a degree of coupling in the cross-coupling of the first effect processing signal and the second effect processing signal in the cross-coupling.
